(19) United States
(12) Patent Application Publication
(10) Pub. No.: US 2007/0221015 A1
(43) Pub. Date: Sep. 27, 2007

(54) Bendable hand tool

(76) Inventor: Chih-Ching Hsieh, Taichung Hsien (TW)

Correspondence Address: Chih-Ching Hsieh, 235 Chung - Ho, Box 8-24, Taipei, TW

(21) Appl. No.: 11/386,980

(22) Filed: Mar. 23, 2006

(51) Int. Cl. B25B 23/16; B25G 1/00

(52) U.S. Cl. 81/177.7; 81/177.8

(57) ABSTRACT

A bendable hand tool comprises a handle having a pivotal section at a front end thereof; the pivotal section being formed with a through hole; an extension block for increasing the arm of the force of the handle tool as the hand tool is bent; a front end of the extension block being formed with a head; an upper end of the extension block being formed with a pivotal hole corresponding to the pivotal section of the handle; when the pivotal hole being aligned to the through hole of the pivotal section, a pivotal shaft passing through the pivotal hole and the through hole and thus the pivotal section being pivotally installed to the handle; and a head installed upon the upper end of the extension block. A display is installed on the handle. An internal of the display is installed with an integrated element.

### FIELD OF THE INVENTION

The present invention relates to hand tools, and in particular to a bendable hand tool, wherein the angle between the head and handle of the hand tool is adjustable and the arm of force for adjusting the hand tool is long so that force can be transferred to the driving device effectively. Thereby a strain gauge is installed to the hand tool.

### BACKGROUND OF THE INVENTION

Generally, the head and handle of a hand tool are arranged at a fixed plane. They are not rotatable with one another. However as the hand tool is applied to a special working place. The hand tool is not suitable and thus it will affect the work of the users. Thereby there is an improved design for overcoming this defect. In one design, the angle is existed between the head and the handle. However the angle is fixed (un-adjustable) and thus it is only suitable for some specific working places.

Thus, the angle adjustable hand tools are developed, in that the angle between the head and the handle is adjustable. However this prior art still has the defect of low arm of force as the angle between the head and handle. Thus, the force from the user's hand to a driven device is reduced.

Thereby above mentioned hand tool has no strain gauge due to the small volume. Thus the tightness of the driven device cannot be measured. It is possible that the force applied is too large so as to destroy the driven device.

### SUMMARY OF THE INVENTION

Accordingly, the primary object of the present invention is to provide a bendable hand tool, wherein the angle between the head and handle of the hand tool is adjustable and the arm of force for adjusting the hand tool is long so that force can be transferred to the driving device effectively. Thereby a strain gauge is installed to the hand tool.

To achieve above objects, the present invention provides a bendable hand tool which comprises a handle having a pivotal section at a front end thereof; the pivotal section being formed with a through hole; an extension block for increasing the arm of the force of the handle tool as the hand tool is bent; a front end of the extension block being formed with a head; an upper end of the extension block being formed with a pivotal hole corresponding to the pivotal section of the handle; when the pivotal hole being aligned to the through hole of the pivotal section, a pivotal shaft passing through the pivotal hole and the through hole and thus the pivotal section is pivotally installed to the handle; and a head installed upon the upper end of the extension block. A display is installed on the handle. An internal of the display is installed with an integrated element for receiving information to get the values of twisting force and the result is displayed on the display.

The various objects and advantages of the present invention will be more readily understood from the following detailed description when read in conjunction with the appended drawing.

### BRIEF DESCRIPTION OF THE DRAWINGS

FIG. 1 is an exploded perspective view of the bendable hand tool of the present invention.

FIG. 2 is a perspective view of the bendable hand tool of the present invention.

FIG. 3 is a lateral view of the present invention.

FIG. 4 is a schematic view showing the use of the present invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

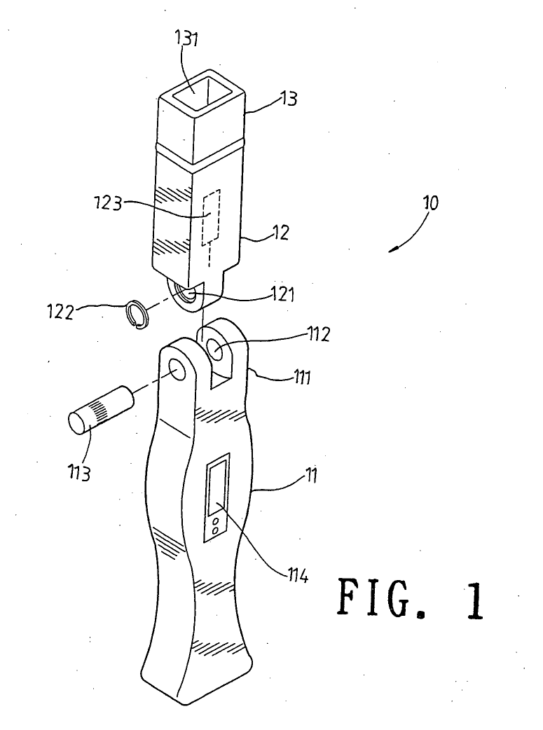

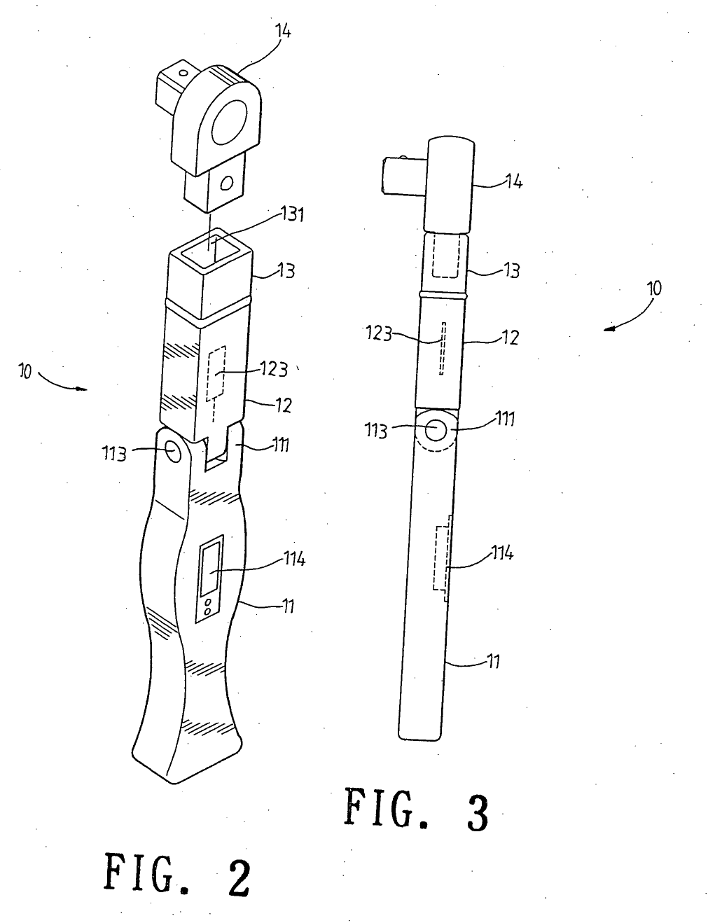

Referring to FIGS. 1 to 3 the structure of the present invention is illustrated. The present invention is related to a handle tool 10 which has the following components.

A handle 11 has a pivotal section 111 at a front end thereof. The pivotal section 111 is formed with a through hole 112. A display 114 is installed on the handle 11. An internal of the display 114 is installed with an integrated element (not shown) for receiving information to get the values of twisting force and the result is displayed on the display 114.

An extension block 12 is a long block for increasing the arm of the force of the handle tool 10 as the hand tool 10 is bent. A front end of the extension block 12 is formed with a head 13. An upper end of the extension block 12 is formed with a pivotal hole 121 corresponding to the pivotal section 111 of the handle 11. When the pivotal hole 121 is aligned to the through hole 112 of the pivotal section 111, a pivotal shaft 113 passes through the pivotal hole 121 and the through hole 112 and thus the pivotal section 111 is pivotally installed to the handle 11. A C ring is engaged to a lateral side of the pivotal hole 121 for enhancing the combining strength of the hand tool. The extension block 12 is installed with a strain gauge 123 which is connected to the display 114. The strain gauge 123 will cause variation of the resistance due to the strain applied thereto. Thereby, the integrating element of the display 114 can calculate the twisting force.

The head 13 is installed upon the upper end of the extension block 12. In this embodiment, the head 13 has an engaging hole 131 for engaging a driving head 14. Further, the present invention the head 13 may have a shape of the driving head 14.

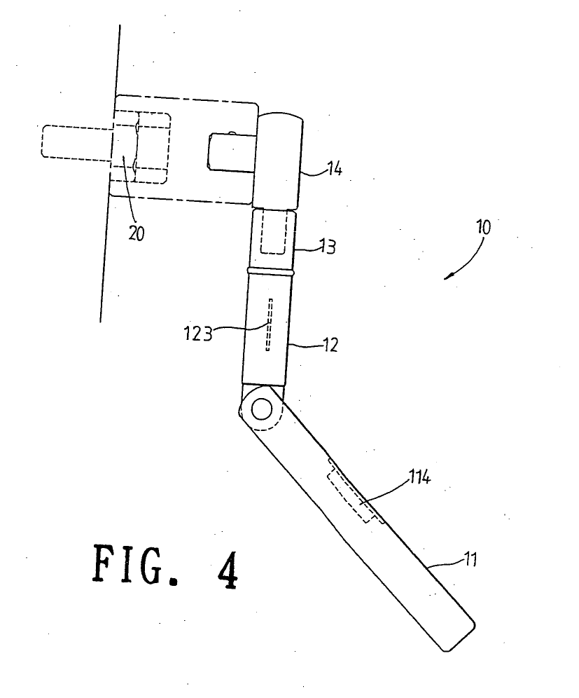

Referring to FIG. 4, in use of the present invention, the orientation between the handle 11 and the pivotal section 111 can be adjusted as desired. In the present invention, since the head 13 is installed at an upper end of the extension block 12 to increase the whole structure strength of the hand tool. Thus, a sufficient arm of force is provided to drive a screw unit 20. Thereby, the extension block 12 is long. If it is desired to install a strain gauge 123, it has a sufficient space for installing the strain gauge 123 thus the strain gauge 123 is well protected not to be destroyed. Thereby, the twisting force can be measured effectively.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

1. A bendable hand tool comprising:
a handle having a pivotal section at a front end thereof; the pivotal section having an approximate U shape and thus having two extension sheets; each extension sheet of the pivotal section being formed with a respective through hole;
an extension block for increasing the arm of the force of the handle tool as the hand tool is bent; a front end of the extension block; a lower end of the extension block having an extension protrusion; the extension protrusion being formed with a pivotal hole; the extension protrusion being installed between the two extension sheets of the pivotal section and the pivotal hole being aligned to the through holes of the pivotal section, a pivotal shaft passing through the pivotal hole and the through hole and thus the pivotal section is pivotally installed to the handle; and
a head installed upon the upper end of the extension block; and
a strain gauge being installed in the extension block.
wherein the handle 11 has four sides; two opposite sides are planes; and the other two opposite sides are cambered sides; each cambered side has an S shape and the two opposite sides are approximately symmetrical to a longitudinal axis of the handle 11; the two opposite sides are formed with an enlarged middle portion below the pivotal section 111, a reduced portion below the enlarged portion; and an enlarged lower portion with a flat bottom end.

2. The bendable hand tool as claimed in claim 1, wherein the head having an engaging hole for engaging a driving head.

3. The bendable hand tool as claimed in claim 1, wherein the head is formed as a driving head.

4. The bendable hand tool as claimed in claim 1, wherein the hand tool is formed as a spanner.

5. The bendable hand tool as claimed in claim 1, wherein the head and extension block are integrally formed.

6. The bendable hand tool as claimed in claim 1, wherein a display is installed on the handle; an internal of the display is installed with an integrated element for receiving information to get the values of twisting force and the result is displayed on the display.

7. The bendable hand tool as claimed in claim 6, wherein the extension block is installed with the strain gauge which is connected to the display.

8. The bendable hand tool as claimed in claim 1, wherein the extension block is a long block.

9. The bendable hand tool as claimed in claim 1, wherein a C ring is engaged to a lateral side of the pivotal hole for enhancing the combining strength of the hand tool.
